(19) United States
(12) Patent Application Publication
(10) Pub. No.: US 2008/0212531 A1
(43) Pub. Date: Sep. 4, 2008

(54) METHOD AND SYSTEM FOR TRANSMITTING/RECEIVING SIGNAL IN A COMMUNICATION SYSTEM

(75) Inventors: Jeong-Ho Park, Seoul (KR); Tae-Young Kim, Seongnam-si (KR); Jae-Hee Cho, Seoul (KR); Nam-Gi Kim, Suwon-si (KR); Kwan-Hee Roh, Hwaseong-si (KR); Jin-Kyu Koo, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/041,250

(22) Filed: Mar. 3, 2008

(30) Foreign Application Priority Data
Mar. 2, 2007 (KR) 2007-21193

(51) Int. Cl. H04Q 7/00

(52) U.S. Cl. 370/329

(57) ABSTRACT

A method and system for transmitting a signal in a communication system is disclosed, in which a BS transmits control information in a predetermined third zone of a frame, the frame being divided into a first and a second zones in frequency and the third zone being included in the first zone, and transmits a data burst in at least one of a fourth zone and the second zone, the fourth zone being a remaining zone of the first zone other than the third zone.

### PRIORITY

This application claims priority under 35 U.S.C. §119(a) to a Korean Patent Application filed in the Korean Intellectual Property Office on Mar. 2, 2007 and assigned Serial No. 2007-21193, the entire disclosure of which is hereby incorporated by reference.

### BACKGROUND OF THE INVENTION

1. Field of the Invention

The present invention generally relates to a communication system. More particularly, the present invention relates to a method and system for generating a frame in a communication system.

2. Description of the Related Art

A future-generation communication system is being developed to provide high-speed large-data transmission/reception service to Mobile Stations (MSs). A major example of the future-generation communication system is the Institute of Electrical and Electronics Engineers (IEEE) 802.16e system

With reference to FIG. 1, the configuration of an IEEE 802.16e communication system is now described.

Referring to FIG. 1, the IEEE 802.16e communication system has a multi-cellular structure. Thus, it has cells 100 and 110, a Base Station (BS) 120 for managing the cell 100, a BS 130 for managing the cell 110, and a plurality of MSs 140, 145, 150, 155 and 160.

In the IEEE 802.16e communication system, a frame includes a preamble for downlink or uplink transmission, a MAP message for providing frame control information and resource allocation information for users, and subchannels. The subchannels are categorized into band Adaptive Modulation and Coding (AMC) subchannels and diversity subchannels according to their configurations.

The total frequency band of the IEEE 802.16e communication system is divided into a plurality of subbands (or bands). One band AMC subchannel is formed with one or more successive subcarriers in a band. For generation of band AMC subchannels, a BS receives feedback Channel Quality Information (CQIs) about the bands from MSs within the BS and generate band AMC subchannels that can provide the best channel statuses to the MSs based on the CQIs. Since each band AMC subchannel has successive subcarriers, it is in a constant channel status over the subcarriers. Therefore, an MS can apply a suitable AMC scheme to its band AMC subchannel, thereby maximizing transmission capacity.

As compared to the band AMC subchannel, the diversity subchannel is formed with one or more subcarriers distributed over the entire frequency band in the IEEE 802.16e communication system. Thus, the diversity subchannel offers frequency diversity gain. In general, a radio channel varies in time and frequency domains. When it is impossible to transmit a signal adaptively according to the channel status of a specific MS, it is preferable that the MS acquires a diversity gain by receiving the signal in a good channel status sometimes or in a poor channel status at other times. That's the reason for generating the diversity subchannel.

In order to generate band AMC subchannels and diversity subchannels, the IEEE 802.16e communication system adopts a multiple zone structure for a frame.

The multiple zone structure refers to dividing the frame into a band AMC subchannel zone and a diversity subchannel zone in the time domain according to Time Division Multiplexing (TDM), so that band AMC subchannels are generated in the band AMC subchannel zone and diversity subchannels in the diversity subchannel zone.

As the duration of an IEEE 802.16e frame is sufficiently long in time, the diversity subchannels and the band AMC subchannels are supported by TDM.

However, some time delay occurs due to the long frame when an MS measures the CQI of a downlink and feeds back the CQI to a BS and then the BS schedules the downlink based on the CQI. The resulting channel status mismatch between the BS and the MS degrades the performance of the communication system.

To avert this problem, a short frame has been proposed. When the BS generates the short frame in TDM, there is a shortage of a time space that can support multiple subchannels including band AMC subchannels and diversity subchannels at various ratios. In this context, Frequency Division Multiplexing (FDM) has been proposed for generating the short frame.

For generating an FDM frame, the communication system supports the band AMC subchannels and the diversity subchannels in different frequencies at the same time period in every frame and changes the positions and sizes of the band AMC subchannels and the diversity channels in every frame. Hence, the BS generates band AMC subchannel position/size information. If the band AMC subchannel position/size information is transmitted on a separately procured channel, the overhead of the communication system is increased. Accordingly, there is needed a technique for extracting the band AMC subchannel position/size information irrespective of the ratio of the multi-subchannel zones that are changed in every frame, while minimizing the increase of overhead in a communication system.

### SUMMARY OF THE INVENTION

An aspect of the preferred embodiments of the present invention is to address at least the problems and/or disadvantages above and to provide at least the advantages described below. Accordingly, an aspect of the preferred embodiments of the present invention is to provide a method and system for extracting band AMC subchannel position/size information irrespective of the ratio of multi-subchannel zones that are changed in every frame, while minimizing the increase of overhead in a communication system.

In accordance with another aspect of the preferred embodiments of the present invention, there is provided a method for transmitting a signal in a BS, in which control information is transmitted in a predetermined third zone of a frame, the frame being divided into a first and a second zones in frequency and the third zone being included in the first zone, and a data burst is transmitted in at least one of a fourth zone and the second zone, the fourth zone being a remaining zone of the first zone except for the third zone.

In accordance with still another aspect of the preferred embodiments of the present invention, there is provided a method for receiving a signal in an MS, in which synchronization to a BS is acquired, a third zone included in a first zone of a frame is received, and a data burst allocated to the MS is received in at least one of a fourth zone and a second zone, the fourth zone being a remaining zone of the first zone except for the third zone, using control information included in the third zone. Herein, the first and the second zones are distinguished by frequency resources.

In accordance with a further aspect of the preferred embodiments of the present invention, there is provided a system for transmitting and receiving a signal, in which a BS transmits control information in a predetermined third zone of a frame, the frame being divided into a first and a second zones in frequency and the third zone being included in the first zone, and transmits a data burst in at least one of a fourth zone and the second zone, the fourth zone being a remaining zone of the first zone except for the third zone, and an MS acquires synchronization to the BS, receives the third zone included in the first zone of the frame, receives an allocated data burst in at least one of the fourth zone and the second zone using control information included in the third zone.

### BRIEF DESCRIPTION OF THE DRAWINGS

The above and other objects, features and advantages of certain preferred embodiments of the present invention will be more apparent from the following detailed description taken in conjunction with the accompanying drawings, in which:

FIG. 1 illustrates the configuration of a conventional IEEE 802.16e communication system;

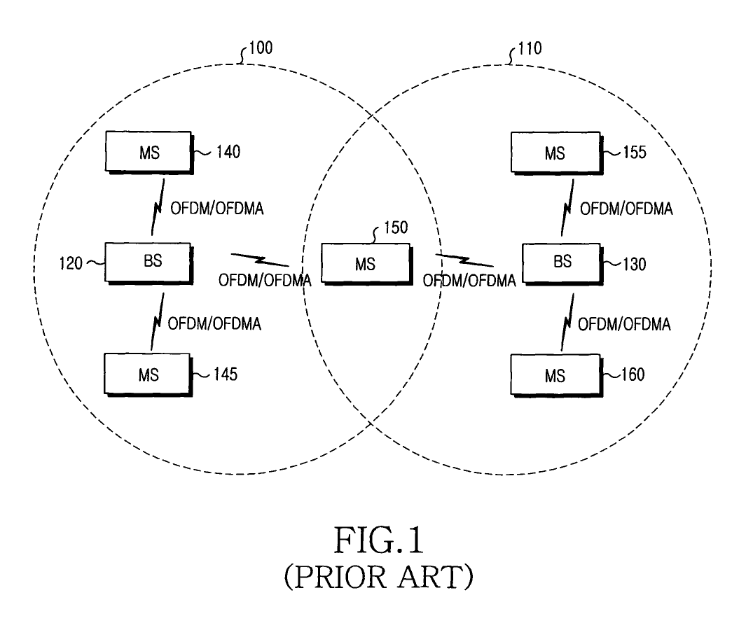

FIG. 2 is a flowchart illustrating a frame generation operation of a BS in a communication system according to exemplary preferred embodiment of the present invention;

FIG. 3 illustrates a frame structure in the communication system according to a preferred embodiment of the present invention;

FIG. 4 illustrates a bitmap indicating the position of a band AMC subchannel zone in the communication system according to a preferred embodiment of the present invention; and

FIG. 5 is a flowchart illustrating a frame decoding operation of an MS in the communication system according to exemplary preferred embodiment of the present invention.

Throughout the drawings, the same drawing reference numerals will be understood to refer to the same elements, features and structures.

### DETAILED DESCRIPTION OF PREFERRED EMBODIMENTS

The matters defined in the description such as a detailed construction and elements are provided to assist in a comprehensive understanding of the preferred embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Preferred embodiments of the present invention provide a method and system for extracting band AMC subchannel position/size information irrespective of the ratio of multi-subchannel zones that are changed in every frame, while minimizing the increase of overhead in a communication system.

While the present invention applies to an Orthogonal Frequency Division Multiple Access (OFDMA) communication system, it is also applicable to all communication systems.

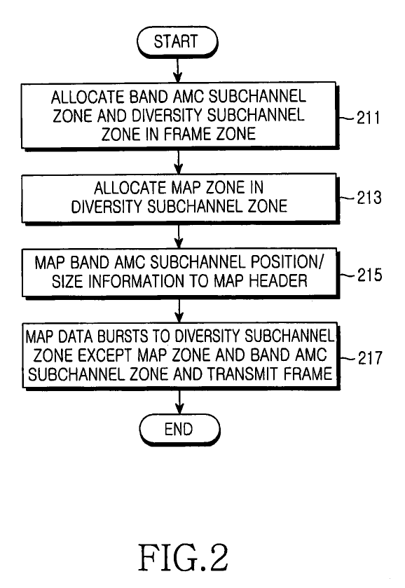

FIG. 2 is a flowchart illustrating a frame generation operation of the BS in a communication system according to a preferred embodiment of the present invention.

Referring to FIG. 2, the BS allocates a band AMC subchannel zone in a frame zone based on CQIs received from MSs and allocates the remaining zone as a diversity subchannel zone in step 211, with a preamble residing at the start of the frame zone.

In step 213, the BS allocates a MAP zone of a predetermined maximum MAP zone size (R_max) or smaller in the diversity subchannel zone. The MAP zone includes a MAP header and a MAP body, in which R_max may vary when needed or periodically.

The BS generates band AMC position/size information indicating the position and size of the band AMC subchannel zone and maps the band AMC position/size information to the MAP header in step 215.

The BS may generate the band AMC subchannel position/size information by bitmap data and map the bitmap data to the MAP header. In addition to the band AMC position/size information, the BS may map MAP body position information indicating the position and size of the MAP body to the MAP header.

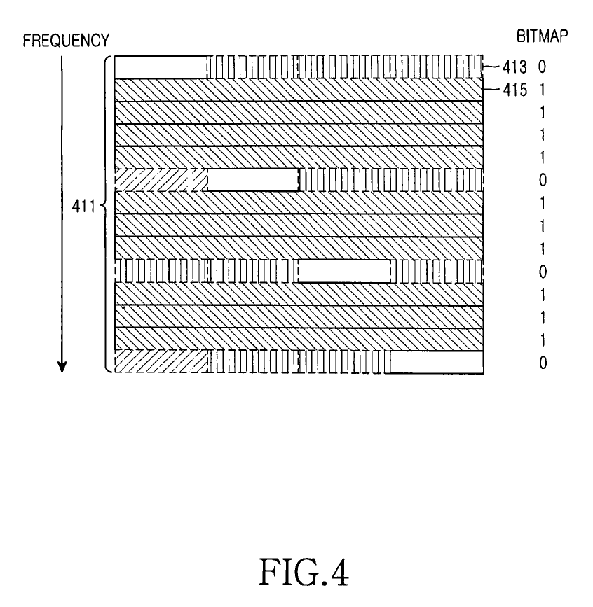

The bitmap data representing the band AMC subchannel position/size information will be described later in detail with reference to FIG. 4.

In step 217, the BS generates a frame by mapping data to the diversity subchannel zone except for the MAP zone and the band AMC subchannel zone and transmits the frame in FDM to the MSs.

When generating the frame, the BS encodes the MAP header to a predetermined size in a predetermined coding and modulation scheme and includes information about the position of the MAP header in the preamble.

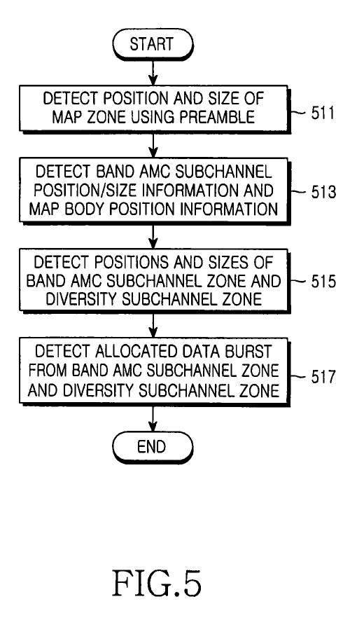

Thus, the MSs can detect and decode the MAP header even though they are not aware of the positions and sizes of the band AMC subchannel zone and the diversity subchannel zone. More specifically, an MS receives a frame, detects a preamble from the frame, and detects a MAP header in a diversity subchannel zone using MAP header position information included in the preamble. The MS can decode the MAP header in a predetermined coding and modulation scheme. Using the decoded MAP header, the MS can detect band AMC subchannel position/size information and determine the position and size of a band AMC subchannel zone based on the band AMC subchannel position/size information. The MS can detect data at the position of the band AMC subchannel zone. This frame reception and data detection process of the MS will be detailed later with reference to FIG. 5.

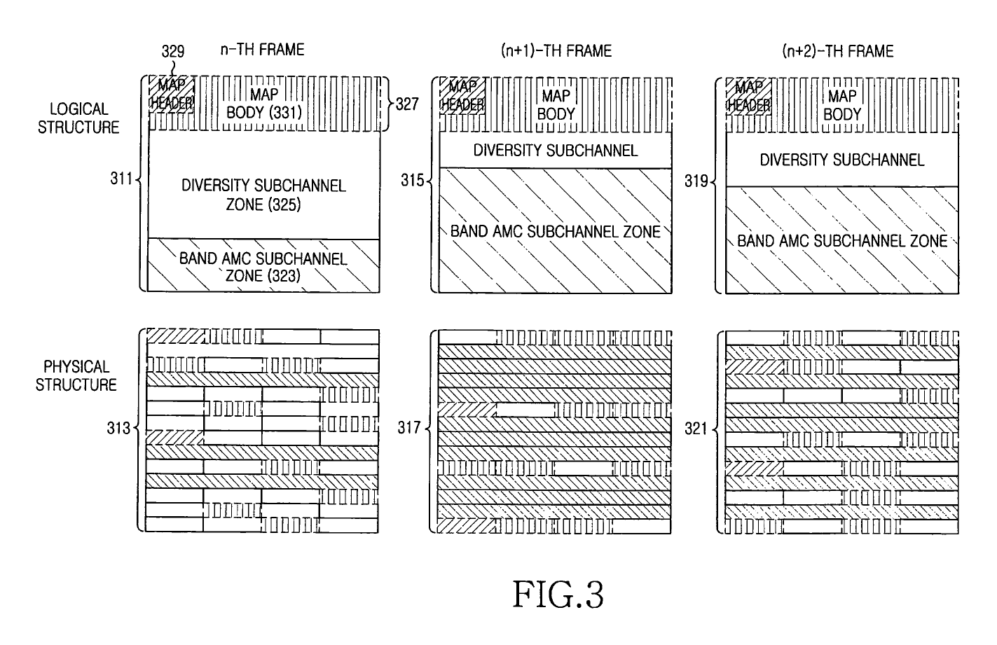

FIG. 3 illustrates the structure of a frame transmitted from the BS according to the present invention The BS generates a frame by changing the positions and sizes of band AMC subchannels and diversity subchannels based on the CQIs received from MSs every frame. The frame can have the structure illustrated in FIG. 3.

Referring to FIG. 3, references numerals 311, 315 and 319 denote logical frame structures and reference numerals 313, 317 and 321 denote physical frame structures. Specifically, the frame 311 is the logical structure of an n^{th} frame and the frame 313 is a physical version of the frame 311. The frame 315 is a logical structure of an (n+1)^{th} frame and the frame 317 is a physical structure of the frame 315. The frame 319 is a logical structure of an (n+2)^{th} frame and the frame 321 is a physical structure of the frame 319.

The BS allocates a band AMC subchannel zone 323 in a frame zone such as the frame 3 11, taking into account a MAP zone 327 to be included in a diversity subchannel zone 324 and allocates the diversity subchannel zone 324 in the remaining frame zone. The BS also allocates the MAP zone 327 of up to a maximum MAP zone size R_max in the diversity subchannel zone 325. The BS can allocate a MAP header 329 and a MAP body 331 in the MAP zone 327 and map band AMC subchannel position/size information and MAP body position information to the MAP header 329.

If the BS generates a frame with a maximized band AMC channel zone, it secures a MAP zone of size R_max or smaller as in the frame 315 and then generates the band AMC subchannel zone.

If the BS generates a frame with a band AMC channel zone smaller than the maximized band AMC channel zone, it secures a MAP zone of size R_max or smaller as in the frame 319 and then generates the band AMC subchannel zone.

FIG. 4 illustrates a bitmap indicating the position of a band AMC subchannel zone in the communication system according to a preferred embodiment of the present invention.

In an FDM frame, the BS transmits band AMC subchannels and diversity subchannels in different frequency bands. To indicate whether a subchannel transmitted in every frequency band is a band AMC subchannel or a diversity subchannel, the BS sets a bit corresponding to the subchannel to a predetermined value that forms band AMC subchannel position/size information. The BS arranges bit values corresponding to subchannels in the order of the positions of the subchannels and forms a bitmap with the arranged bit values. The bitmap is set as the band AMC subchannel position/size information.

A frame 411 is a physical frame. The frame 411 can be divided into a plurality of parts along the frequency axis, each part including a subchannel. The BS can set bit values for the individual subchannels.

For example, if a subchannel is a diversity subchannel, a bit corresponding to the subchannel is set to “0”. If a subchannel is a band AMC subchannel, a bit corresponding to the subchannel is set to “1”. In the first of 14 parts in the frame 411, a subchannel 413 is a diversity subchannel. Thus, the BS sets a bit corresponding to the subchannel 413 to “0”. A subchannel 415 residing in the second part is an AMC subchannel and thus a bit corresponding to the subchannel 415 is set to “1”. In this manner, the BS sets bit values for the subchannels of the respective parts of the frame 411 and forms a bitmap with 14 bit values of “01111011101110”.

In another example if a subchannel is a diversity subchannel, a bit corresponding to the subchannel is set to “1”. If a subchannel is a band AMC subchannel, a bit corresponding to the subchannel is set to ‘0’. In the first of the 14 parts in the frame 411, the subchannel 413 is a diversity subchannel. Thus, the BS sets a bit corresponding to the subchannel 413 to “1”. The subchannel 415 residing in the second part is an AMC subchannel and thus a bit corresponding to the subchannel 415 is set to “0”. In this manner, the BS sets bit values for the subchannels of the respective parts of the frame 411 and forms a bitmap with 14 bit values of “10000100010001”.

FIG. 5 is a flowchart illustrating a frame decoding operation of an MS in the communication system according to a preferred embodiment of the present invention.

Referring to FIG. 5, the MS receives a preamble in a frame, acquires synchronization to a BS using the preamble, detects and analyzes MAP header position information included in the preamble, and detects the position of a MAP header based on the analysis in step 511.

In every frame, the positions and sizes of a band AMC subchannel zone and a diversity subchannel zone are changed. The frame includes a preamble, a band AMC subchannel zone, and a diversity subchannel zone. The preamble includes MAP header position information and the diversity subchannel zone includes a MAP zone of size R_max or smaller. The MAP zone is divided into a MAP header and a MAP body. The MAP header includes band AMC subchannel position/size information and MAP body position information, and the MAP body includes frame control information and resource allocation information for users.

In step 513, the MS detects a MAP header at the detected MAP header position, detects band AMC subchannel position/size information and MAP body position information from the MAP header.

The MS acquires the information of the positions and sizes of a band AMC subchannel zone and a diversity subchannel zone in the frame by analyzing the band AMC subchannel zone position/size information in step 515.

For example, if the band AMC subchannel zone position/size information is a bitmap with bit values “01111011101110” where “0” indicates a diversity subchannel and “1” indicates a band AMC subchannel, the MS determines that the frame is divided into 14 parts according to the number of bit values included in the bitmap. Also, the MS determines that a diversity subchannel is in the first of the 14 parts, band AMC subchannels in the second to fifth parts, a diversity subchannel in the sixth part, band AMC subchannels in the seventh, eighth, and ninth parts, a diversity subchannel in the tenth part, band AMC subchannels in the 11^{th}, 12^{th} and 13^{th} parts, and a diversity subchannel in the last 14^{th} part.

In step 517, the MS detects data bursts allocated to it from the band AMC subchannel zone and the diversity subchannel zone.

More specifically, the MS detects a MAP body in the diversity subchannel zone by analyzing the detected MAP body position information and then searches resource allocation information for users in the MAP body. The MS then determines positions allocated to it in the band AMC subchannel zone and the diversity subchannel zone by analyzing the resource allocation information and detects data bursts at the positions in the band AMC subchannel zone and the diversity subchannel zone.

As is apparent from the above description, the present invention can advantageously provide band AMC subchannel position/size information irrespective of the ratio of multi-subchannel zones that may vary in every frame, while minimizing an overhead increase in a communication system.

While the invention has been shown and described with reference to certain preferred embodiments of the present invention thereof, it will be understood by those skilled in the art that various changes in form and details may be made therein without departing from the spirit and scope of the present invention as defined by the appended claims and their equivalents.

What is claimed is:

1. A method for transmitting a signal in a Base Station (BS), comprising:
transmitting control information in a predetermined third zone of a frame, the frame being divided into a first zone and a second zone in frequency and the third zone being included in the first zone; and
transmitting a data burst in at least one of a fourth zone and the second zone, the fourth zone being a remaining zone of the first zone other than the third zone.

2. The method of claim 1, further comprising generating the frame, wherein the frame generation comprises:
allocating the second zone in the frame, allocating the first zone in a remaining zone of the frame, and allocating the third zone including a fifth and a sixth zone in the first zone;
mapping position information about the fifth zone to a preamble of the frame;
mapping band Adaptive Modulating and Coding (AMC) subchannel position/size information of the position and size of a band AMC subchannel zone and position information of the sixth zone to the fifth zone, and mapping frame control information and resource allocation information for users to the sixth zone; and
mapping at least one data burst to at least one of the second and the fourth zones.

3. The method of claim 2, wherein the second zone allocation comprises:
allocating the first zone after allocating the second zone so that a maximum size R_max of the third zone can be secured; and
allocating the third zone of the maximum size R_max or smaller in the first zone.

4. The method of claim 3, wherein the maximum size R_max is variable periodically.

5. The method of claim 2, wherein the band AMC subchannel position/size information is generated in a form of a bitmap.

6. The method of claim 2, wherein the first zone is a diversity subchannel zone, the second zone is a band AMC subchannel zone, the third zone is a MAP zone, the fifth zone is a MAP header zone, and the sixth zone is a MAP body zone.

7. A method for receiving a signal in a Mobile Station (MS), comprising:
acquiring synchronization to a Base Station (BS), receiving a third zone included in a first zone of a frame; and
receiving a data burst allocated to the MS in at least one of a fourth zone and a second zone, the fourth zone being a remaining zone of the first zone other than the third zone, using control information included in the third zone,
wherein the first zone and the second zone are distinguished by frequency resources.

8. The method of claim 7, wherein the data burst reception comprises:
receiving a fifth zone using position information about the fifth zone included in a preamble of the frame and determining the positions and sizes of the first zone and the second zone by analyzing band Adaptive Modulation and Coding (AMC) subchannel position/size information included in the fifth zone; and
receiving a sixth zone using position information about the sixth zone included in the fifth zone, and receiving the data burst allocated to the MS in the at least one of the second zone and the fourth zone using frame control information and resource allocation information included in the sixth zone.

9. The method of claim 8, wherein the band AMC subchannel position/size information is generated in a form of a bitmap.

10. The method of claim 8, wherein the first zone is a diversity subchannel zone, the second zone is a band AMC subchannel zone, the third zone is a MAP zone, the fifth zone is a MAP header zone, and the sixth zone is a MAP body zone.

11. A system for transmitting and receiving a signal, comprising:
a Base Station (BS) for transmitting control information in a predetermined third zone of a frame, the frame being divided into a first zone and a second zone in frequency and the third zone being included in the first zone, and transmitting a data burst in at least one of a fourth zone and the second zone, the fourth zone being a remaining zone of the first zone other than the third zone.

12. The system of claim 11, further comprising a Mobile Station (MS) for acquiring synchronization to the BS, receiving the third zone included in the first zone of the frame, and receiving an allocated data burst in at least one of the fourth zone and the second zone using control information included in the third zone.

13. The system of claim 11, wherein the BS allocates the second zone in the frame, allocating the first zone in a remaining zone of the frame, and allocating the third zone including a fifth zone and a sixth zone in the first zone, maps position information about the fifth zone to a preamble of the frame, maps band Adaptive Modulating and Coding (AMC) subchannel position/size information about the position and size of a band AMC subchannel zone and position information about the sixth zone to the fifth zone, maps frame control information and resource allocation information for users to the sixth zone, and maps at least one data burst to at least one of the second zone and the fourth zone.

14. The system of claim 13, wherein the band AMC subchannel position/size information is generated in a form of a bitmap.

15. The system of claim 13, wherein the first zone is a diversity subchannel zone, the second zone is a band AMC subchannel zone, the third zone is a MAP zone, the fifth zone is a MAP header zone, and the sixth zone is a MAP body zone.

16. The system of claim 13, wherein the BS allocates the first zone after allocating the second zone so that a maximum size R_max of the third zone can be secured and allocates the third zone of the maximum size R_max or smaller in the first zone.

17. The system of claim 14, wherein the maximum size R_max is variable periodically.

18. The system of claim 12, wherein the MS receives the fifth zone using position information about the fifth zone included in a preamble of the frame, determines the positions and sizes of the first zone and the second zone by analyzing the band AMC subchannel position/size information included in the fifth zone, receives the sixth zone using position information about the sixth zone included in the fifth zone, and receives the data burst allocated to the MS in at least one of the second zone and the fourth zone using the frame control information and the resource allocation information included in the sixth zone.

19. The system of claim 18, wherein the band AMC subchannel position/size information is generated in a form of a bitmap.

20. The system of claim 18, wherein the first zone is a diversity subchannel zone, the second zone is a band AMC subchannel zone, the third zone is a MAP zone, the fifth zone is a MAP header zone, and the sixth zone is a MAP body zone.
